(19) United States
(12) Patent Application Publication
(10) Pub. No.: US 2006/0026184 A1
(43) Pub. Date: Feb. 2, 2006

(54) Generation and use of files having embedded location information

(75) Inventors: Eric J. Hewing, Dallas, TX (US); Leonardo W. Estevez, Rowlett, TX (US); Richard M. Baker, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/875,348

(22) Filed: Jun. 24, 2004

(51) Int. Cl. G06F 7/00

(52) U.S. Cl. 707/101

(57) ABSTRACT

Various apparatus and methods permit data to be associated with location information pertaining to the location at which the data was created or last updated. In accordance with various methods, data associated with location information can be used in various ways such as searching and archiving the data based on location, associating the data with locations on a digital map at which the data was created, modified, or last viewed, and the like.

### BACKGROUND

1. Technical Field

The present subject matter relates generally to files having location information embedded therein. More particularly, the present subject matter relates to generating files (e.g., digital images) in which global positioning system (“GPS”) data is included for subsequent searching and archiving.

2. Background Information

The proliferation of mobile devices with a high level operating system will allow content to be created virtually anywhere. Digital cameras and camera phones, for example, have already facilitated taking and amassing a large quantity of pictures. This leaves many photographers with an overwhelming amount of pictures to search, archive and manage. By way of further example, documents can be created in a coffee shop or voice memos can be created in the car on the way to work. In general, mobile devices can create many different types of content including video, image, audio, and text files leading to a content management problem.

### BRIEF SUMMARY

In accordance with at least one embodiment of the invention, a portable image capture system comprises a processor, an image capture unit coupled to the processor, and location logic adapted to determine the location of the system. The image capture unit preferably is adapted to acquire images. The processor stores the images along with location information from the location logic. The location information is indicative of the location of the system.

In accordance with another embodiment, a system comprises a processor having access to files, each file being associated with location information indicative of the location at which the associated file was created or last updated. Such information can be stored in the file itself or in file system attributes (such as the NT File System). The system also includes code that is executable on the processor and that permits a user of the system to search files containing location information.

In accordance with yet another embodiment, a system comprises a processor and non-volatile storage coupled to the processor. The non-volatile storage stores files containing location information that represents the location at which the file was created. The storage also contains information representative of the location that a file was last accessed. The system also includes code that is executable on the processor that causes the processor to organize the files in the non-volatile storage based on the location information.

Various methods are also disclosed herein. For example, one preferred method comprises obtaining data, obtaining a location indicator indicative of a location at which the data was obtained, and storing the data and the location indicator in a file. Another method comprises searching files, each file containing a location identifier indicative of a location at which the file was created or last updated. Yet another method comprises receiving a location from a user, searching a plurality of files based on the location, each of the files containing a location identifier indicative of the location at which said file was created or last updated, and accessing a file whose location identifier corresponds to the location received from the user. Another method comprises receiving a file, such as a digital photograph, containing location information, the location information reflective of the location at which the photograph was taken and associating the digital photograph with a location on a digital map. The location on the digital map corresponds to the location information encoded in the digital photograph.

### Notation and Nomenclature

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to.” Also, the term “couple” or “couples” is intended to mean either an indirect or direct connection. Thus, if a first device couples to a second device, that connection may be through a direct connection, or through an indirect connection via other devices and connections.

### BRIEF DESCRIPTION OF THE DRAWINGS

For a more detailed description of the preferred embodiments of the present invention, reference will now be made to the accompanying drawings, wherein:

FIG. 1 shows a portable system comprising location logic adapted to produce location information that is associated with a file;

FIG. 2 shows a system configured to access files encoded with location information;

FIGS. 3-5 provide various methods related to the apparatus of FIGS. 1 and 2; and

FIG. 6 shows a location name resolver which converts location names to corresponding coordinates.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary, of that embodiment, and not intended to intimate that the scope of the disclosure, including the claims, is limited to that embodiment.

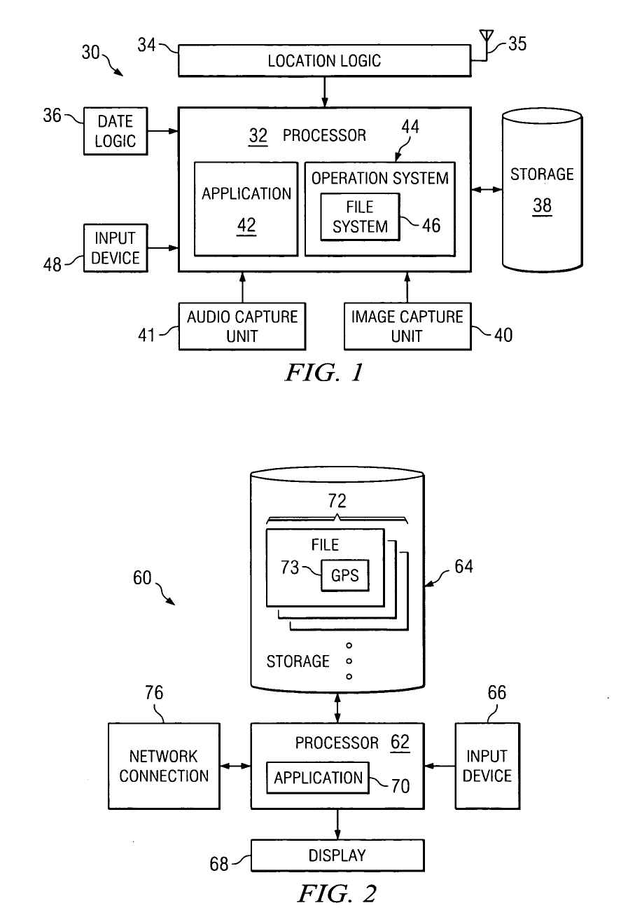

FIG. 1 shows a system 30 comprising a processor 32, location logic 34, date logic 36, storage 38, an image capture unit 40, and an audio capture unit 41. The system 30 preferably is portable and thus susceptible to being used in various locations (e.g., different sites within a city, different cities, different sites along a highway, etc.). The system 30 may comprise a digital camera, a camera phone, or other portable image-capture device.

The location logic 34 comprises any type of circuitry that can be used to provide a signal to the processor indicative of the location of the system 30. The resolution and accuracy of the location determined by the location logic 34 is application specific and thus can vary as desired. In some embodiments, the location logic 34 comprises GPS receiver having an antenna 35. In general, the location logic 34 provides coordinates of the system's location to the processor 32. The location logic 34 may provide the coordinates to the processor 32 at periodic intervals or in response to a request sent by the processor to the location logic 34 for such information.

The date logic 36 also provides information to the processor 32. The information provided by the date logic includes the current date. The date provided by the date logic to the processor may be provided at periodic intervals or upon specific date requests sent by the processor 32 to the date logic 36. The date may include just the day, just the month, just the year, just the month and year, just the day and month, or the day, month and year, other desired format. The date may also include time information. The date logic 36 may thus include circuitry capable of keeping track of the current date and time.

The image capture unit 40 comprises a device that is capable of taking photographs or acquiring video and thus acquiring digital images or video of the subject matter being photographed. Image capture unit 40 may be image capture devices that are typically included in a digital camera or camera phone. Via user input from input device 48 (which, for example, may comprise a button on a camera or camera phone), the processor 32 preferably causes the image capture unit 40 to take a photograph. The audio capture unit 41 can be made to acquire audio information (e.g. voice, music, etc.). This disclosure is not limited to any particular type of content and generally includes one or more content capture devices such as image capture unit 40 and audio capture unit 41.

The storage 38 comprises any suitable type of storage medium in which data can be stored. Storage 38 may comprise volatile storage (e.g., random access memory), non-volatile storage (e.g., flash memory, hard drive), or a combination of volatile and non-volatile storage. The storage 38 is used to store the digital images captured by the image capture unit 40.

The processor 32 comprises a microprocessor on which software executes. The software may include an operating system 44 and at least one application 42. The operating system 44 may comprise any operating system suitable for the purposes described herein. A file system 46 may also be included. The file system 46 performs one or more functions such as storing date information from the date logic 36 with the content. The file system 46 may be the NT File System (“NTFS”). Some embodiments may employ a Unix-type inode-based file system in which the “inode” structure for a file is modified to include the location at which the file was created, the location at which the file was last accessed, and/or the location at which the file was last modified. In general, the processor 32 uses the operating system 44 to access the file system 46. The system's software may also comprise an application 42 that comprises code that executes on the processor 32 and that causes the processor 32 to perform one or more of the actions described herein. At least one action performed by application 41 is to compress digital or audio images or video.

FIG. 2 shows another system 60 that comprises a processor 62, storage 64, an input device 66, and a display 68. An application 70 comprises code that is executed by the system's processor 62 and that causes the processor 62 to perform one or more of the actions described herein. The system 60 may comprise a computer system that is either portable or non-portable. The system 30 also is described above as being capable of performing one or more of the actions described herein. In general, system 30 is intended to represent a system capable of creating data, such as digital images, and storing such data with location information. System 60, while similarly capable in some embodiments, is intended to use and manage files containing location information. For example, system 30 may comprise a digital camera or camera phone equipped to encode location information with the digital images. System 60 comprises a computer onto which a user may transfer the digital images for storage and further management.

Referring still to FIG. 2, the storage 64 of system 60 comprises the computer's storage capability and may include volatile storage (random access memory), non-volatile storage (e.g., hard disk drive) or a combination thereof. As shown in FIG. 2 and as will be described below, one or more files 72 may be stored on storage 64. One or more of the files 72 may be encoded with location information 73 (e.g., GPS coordinates). The location information 73 encoded with each file 72 preferably represents the location at which a user created or last updated the associated file. For example, if the file 72 comprises a digital image captured by image capture unit 40 of the portable system 30 (FIG. 1), the location information 73 comprises the location of the system 30 when the image was captured.

In other embodiments, a file 72 may comprise data other than related to a digital image. For example, the file 72 may comprise a text document or spreadsheet and the location information comprises the location of the user when the user created or last edited that file. As such, the user may use a computer having, or having access to, location logic to create or edit a file. Such a computer may similar to that shown in FIG. 2, but includes a location logic device such as location logic 34 shown in FIG. 1. Alternatively, for a non-portable computer, the computer may be instilled with its location in memory instead of requiring a location logic device. When the user creates or otherwise saves a file, the computer retrieves computer's location information and encodes the file with the location information. At any rate, when a user saves a file, the operating system and/or associated file system that runs on the system used by the user obtains and stores location information with the file.

Referring still to FIG. 2, the input device 66 of system 60 may comprise a keyboard, mouse, trackball other type of user input device. The display 68 comprises any suitable type of display such as a liquid crystal display (“LCD”), cathode ray tube (“CRT”), etc. The system 60 may also have a network connection 76 through which the system 60 can communicate with other devices on a network. Examples of such other devices include network attached storage devices, servers, etc.

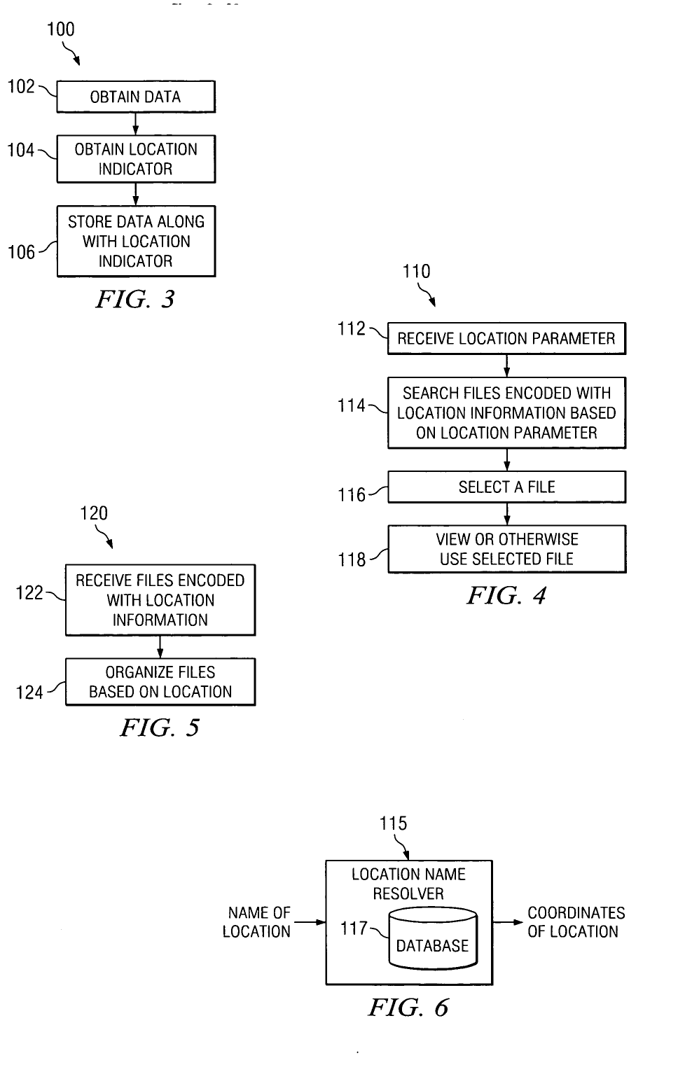

FIG. 3 illustrates a method 100 that can be implemented using the apparatus depicted in FIGS. 1 and/or 2. The method 100 comprises blocks 102, 104, and 106. In block 102, data is obtained. In some embodiments, the data obtained comprises a digital image captured by an image capture unit (e.g., image capture unit 40 in FIG. 1). In other embodiments, block 102 may comprise retrieving an already existing file that may contain a digital image, text document, spreadsheet, or other type of data.

In block 104, a location indicator is obtained. This block may be performed by obtaining location information from location logic 34. In other embodiments, the location indicator may be a location value that is hard-coded into a non-portable system. Block 104 may thus be implemented by retrieving such a hard-coded location value.

In block 106, the data obtained in block 102 is stored along with the obtained location indicator. This block may be performed by storing the location indicator in a header of a file containing the data. In other embodiments, the location identifier is stored in attributes of the file system (e.g., file system 46). If the system 30 comprises a camera or camera-enabled phone, each digital image that is captured may be stored as a file that also contains the location of the system 30 when the image was captured. One exemplary application of method 100 is to take a plurality of digital photographs of, for example, a vacation. Each photograph can be stored in the system's storage 38 along with the location of the user of the system 30 when each photograph was taken. As noted above, the date and/or time the photograph was taken can also be included with the date information. As such, the user of the system 30 need not separately remember or record the time and place each photograph was taken.

FIG. 4 illustrates another method 110 that can be implemented using the apparatus depicted in FIGS. 1 and/or 2. Method 110 includes blocks 112, 114, 116, and 118. In block 112, the method includes receiving a location parameter. This block may be implemented by a user entering a location via input device 66 in FIG. 3 or retrieving a location parameter via the network connection 76. In some embodiments, the user may enter a location parameter in a form compatible with the location information 73 that is stored into the files 72. If the location information 73 comprises GPS coordinates, then the user may enter coordinates via input device 66 in a compatible format. In other embodiments, a user may enter a location parameter in a format that is not compatible with the GPS coordinates 73 encoded in the files 72. A user might, for example, enter the location parameter in form of a city name, for example, “Dallas.” In this latter embodiment, a location name “resolver” can be accessed, for example, on the Internet via the network connection 76. Such a location name resolver is depicted in FIG. 6. Referring briefly to FIG. 6, location name resolver 115 includes, or has access to, a database 117 which enables a conversion between the name of a location (e.g., “Dallas”) and a coordinate or range of coordinates that define the location. A user could also “click” on a map to designate the location. Thus, the name of the location is provided to the location name resolver 115. The location name resolver 115 preferably comprises a server or other type of computing device. The location name resolver 115 accesses the database 117 based on the location name. The database 117 contains coordinates associated with a plurality of location name. If the location name is included in the database 117, the location name resolver retrieves the corresponding coordinates.

Referring again to FIG. 4, in block 114 a plurality of files encoded with location information (as described above) are searched. The files are searched in block 112 preferably based on the location parameter received in block 112. That is, the location information associated with the files is compared against the location parameter received in block 112. In block 116, one or more files out of the plurality of files searched may have location information that falls within or is sufficiently close to the location parameter received in block 112. For example, the location parameter from block 112 may comprise the coordinates that define the city limits of Dallas. The files are searched in block 114 to find one or more files 72 whose stored location information 73 comports with the coordinates of Dallas. In some embodiments, a file 72 is considered to match the received location parameter (block 112) if the location information in a file falls on or within the area defined by the location parameter. In other embodiments, a file 72 is still considered to match the received location parameter if the location information in the file is within a specified (e.g., programmable) distance of the received location parameter. For example, a file whose location information pinpoints a location within 20 miles of the Dallas city limits defined by the received location parameter may considered a match.

In block 116, one or more files (e.g., the files considered to be a location-based match) can be selected for further action. In block 118, that further action may comprise viewing the file (e.g., if the file comprises a digital image) or otherwise using the file. The method of FIG. 4 permits a user to view a digital image of a specific location specified by the user in block 112.

FIG. 5 illustrates another method 120 that can be implemented using the apparatus depicted in FIGS. 1 and/or 2. In block 122, the method comprises receiving files that are encoded with location information. This block may be implemented by retrieving files 72 from the storage 64 of system 60, retrieving files over the network connection 76 of system 60, or retrieving files from the storage 38 of the system 30.

In block 124, the method further comprises organizing the files based on location. This block may include examining the location information in each file, which may comprise location information 73 stored in the header of each file, and placing all files having a common location in a common directory or folder. For example, all files whose location information is indicative of Paris are stored in a common location on a storage medium (e.g., storage 64). As such, all vacation photographs related to a trip to Paris are automatically archived based on the location information encoded within the files containing the photographs.

Organizing the files based on location may also include associating each file with a location on a digital map. A digital map of, for example, the United States can be generated and each digital photograph taken during a trip through the United States may be digitally linked to a location on the map at which that photograph was taken. This embodiment applies to other types of content besides digital photographs.

In some embodiments, a user located in one place (e.g. New York) may attempt to create, access, or modify a file resident in a computer or storage device in another place (e.g. Dallas). The “location” of the file is considered to be either location (New York or Dallas). The designation of how the location of a file is to be determined can be a programmable feature. The user's system may be equipped with or have access to, location logic to determine its location (or have access to a location value if the user's system is not readily portable). Similarly, the device containing the data/file may also be equipped with or have access to, location logic (or have access to a location value) and the system can be configured to use one location logic or the other to provide the locations to associate with the file.

In some embodiments, files are created or otherwise provided that can only be accessed (e.g., viewed) by a user if the user is in a particular location. The particular location could be the location at which the file was originally created or last updated. The particular location could also be a user or system-specified location other than at which the file was created or last updated. A user's file accessing device (e.g., a portable electronic system such as a portable computer) is equipped with location logic such as a GPS receiver and an input device coupled to a processor (see e.g. FIG. 1). The processor receives an input signal from the input device indicative of a file containing location information that the user desires to access. Accordingly, when the user attempts to access the file, the user's system (e.g., the file system) compares the user's current location to location information in the file and permits access to the file if the user's current location comports with the file's location information. The user's current location comports with the file's location information if, for example, the user's location lies substantially on or within a region defined by the files' location information. The resolution of the file's location information can be instilled in the location information itself. For example, a latitude coordinate to 5 decimal places has more resolution than the same latitude coordinate to only 1 decimal place. In some embodiments, the user's current location must be within the location dictated by the location information in the file or within a predetermined distance.

In other embodiments, a file is encrypted using an encryption key. The file can only be decrypted using a suitable key (e.g., the same key used to encrypt the file). When a user desires to access an encrypted file, the user's file system generates a certification key using the user's current location. Once authenticated, the certification key can be used with an encryption key to decrypt the target file. The encryption key may be provided as part of the certification key in accordance other mechanisms.

The file that is accessible only if the user is at a location that comports with the file's location information can be a file that is stored in the user's system or in a remote system.

All of the methods provided above such as, without limitation, methods 100, 110, and 120 depicted in FIGS. 3, 4 and 5, can be performed separately or in conjunction with the other methods.

While the preferred embodiments of the present invention have been shown and described, modifications thereof can be made by one skilled in the art without departing from the spirit and teachings of the invention. The embodiments described herein are exemplary only, and are not intended to be limiting. Accordingly, the scope of protection is not limited by the description set out above.

What is claimed is:

1. A portable system, comprising:
a processor;
a content capture unit coupled to said processor, said content capture unit adapted to acquire data; and
location logic adapted to determine the location of the system;
wherein said processor stores said data along with location information from said location logic, said location information indicative of the location of the system.

2. The system of claim 1 wherein the data comprises images and the processor compresses the images to produce compressed images, each compressed image included within a file, and places the location information in a header of each file containing the compressed images.

3. The system of claim 1 further comprising an application that executes on said processor and that permits a user to search said data based on a location parameter.

4. The system of claim 1 further comprising an application that executes on said processor and that auto-archives said data based on location.

5. The system of claim 4 wherein the application causes the processor to auto-archive said data by storing files containing said data acquired at a common location in a common folder.

6. The system of claim 1 further comprising date logic coupled to the processor, and the processor stores a date obtained from said date logic along with the location information associated with said data, said date being the date on which the data was acquired.

7. The system of claim 1 wherein the portable system is not permitted access to a file if the location of the portable system does not comport with location information stored in said file.

8. A system, comprising:
a processor having access to files, each file being associated with location information indicative of the location at which the associated file was created or last updated; and
code executable on said processor and that permits a user of the system to search files containing location information.

9. The system of claim 8 wherein said files comprise content viewable on said display.

10. The system of claim 8 further comprising non-volatile storage coupled to said processor and wherein said code causes said processor to organize said files in said non-volatile storage based on the location information contained within the files.

11. The system of claim 8 further comprising executable code that causes the processor to produce a map that is viewable on said display, and wherein at least some of said files contain location information that is linked to locations on said map at which the files were created, modified, or last viewed.

12. The system of claim 8 further comprising a display and wherein at least some of said files contain location information in the files, and the system further comprises executable code that causes the processor to receive input from a user of a location and to retrieve and view said file on said display based on the locations received from the user.

13. A system, comprising:
a processor;
non-volatile storage coupled to said processor, said non-volatile storage storing files containing location information that represents the location at which the file was created; and
code executable on said processor that causes said processor to organize said files in said non-volatile storage based on the location information.

14. The system of claim 13 further comprising a display coupled to said processor and said system further comprises executable code that causes the processor to produce a map that is viewable on the display, and wherein at least some of said files contain location information that is linked to locations on said map at which the files were created, modified, or last viewed.

15. The system of claim 13 wherein at least some of said files contain location information, and the system further comprises executable code that causes the processor to receive input from a user of a location and to retrieve a file based on the input and view said file on said display.

16. The system of claim 13 further comprising a display, and wherein said code causes said processor to produce a map that is viewable on the display, and wherein at least some of said files contain location information that is linked to locations on said map at which the files were created, modified, or last viewed.

17. A method, comprising:
obtaining data;
obtaining a location indicator indicative of a location at which the data was obtained;
storing the data and the location indicator in a file.

18. The method of claim 17 further comprising obtaining a date indicator and storing the date indicator in the file with the data and the location indicator.

19. The method of claim 17 wherein the data comprises content created on a mobile device.

20. The method of claim 17 further comprising searching a plurality of files based on a location parameter, each of said plurality of files containing a location indicator.

21. A method, comprising:
searching files, each file containing a location identifier indicative of a location at which the file was created or last updated.

22. The method of claim 21 further comprising selecting a file based on location and viewing the selected file.

23. The method of claim 21 further comprising generating a map and associating at least one file with a location on said map, said at least one file containing a digital image of the location on the map associated with the file.

24. The method of claim 21 wherein said files contain location information and the method further comprises receiving input from a user of a location, retrieving a file based on the user-received location, and viewing contents of the retrieved file.

25. A method, comprising:
receiving a location from a user;
searching a plurality of files based on said location, each of said files containing a location identifier indicative of the location at which said file was created or last updated; and
displaying a file whose location identifier corresponds to the location received from the user.

26. The method of claim 25 further comprising converting the location received from the user to one or more coordinates.

27. A method, comprising:
receiving a file associated with location information, the location information indicative of the location at which the file was created, modified, or last accessed; and
associating the file with a location on a digital map, the location on the digital map corresponding to the location information associated with the file.

28. A method, comprising:
determining a location of an electronic system;
receiving user input from the electronic system to access a file containing location information;
permitting access to said file if the location of the electronic system comports with the location information and precluding access to said file if the location of the electronic system does not comport with the location information.

29. A portable system, comprising:
a processor;
location logic adapted to determine the location of the system; and
an input device coupled to said processor to receive user input, said user input indicative of a file a user desires to access;
wherein the portable system is not permitted access to the file if the location of the portable system does not comport with location information stored in said file.

30. The portable system of claim 29 wherein the location information defines a region and the location of the portable system comports with the location information if the location of the portable system lies substantially on or within the region.
